(19) United States
(12) Patent Application Publication
(10) Pub. No.: US 2019/0241004 A1
(43) Pub. Date: Aug. 8, 2019

(54) GREETING CARD HAVING A CONFIGURABLE HINGE THAT FUNCTIONS AS A SINGLE HINGE IN A TRADITIONAL GREETING CARD MODE, AND AS DOUBLE HINGE WITH A SPINE IN AN ENHANCED MODE BY WHICH TO COOPERATIVELY RECEIVE A RECEPTICLE TO CREATE AN ENHANCED GREETING CARD

(71) Applicant: Raymond Aniban, JR., Ewa Beach, HI (US)

(72) Inventor: Raymond Aniban, JR., Ewa Beach, HI (US)

(21) Appl. No.: 16/386,726

(22) Filed: Apr. 17, 2019

Related U.S. Application Data
(63) Continuation-in-part of application No. 14/545,225, filed on Apr. 8, 2015, now Pat. No. 10,286,715.
(60) Provisional application No. 61/995,493, filed on Apr. 10, 2014.

(51) Int. Cl. B42D 15/04; G09F 1/04

(52) U.S. Cl. CPC B42D 15/045; G09F 1/04

(57) ABSTRACT

A greeting card has a configurable hinge that can operate in a traditional greeting card mode employing a single hinge common to both the front and back cover of the greeting card. The configurable hinge can be reconfigured to operate in an enhanced mode employing two independently operating hinges, one for the front cover and one for the back cover. A folded crease can be used to suppress an existing second hinge for operation in the traditional mode. The state is maintained by adhesive or tape. A line of weakness can also be used for the bending guideline to establish the second hinge and the spine to achieve the enhanced mode. The receptacle has two hinges and a spine, and the receptacle spine is inserted into the greeting card spine achieve alignment of the hinges. The receptacle can be affixed to the back cover of the greeting card. The receptacle stores media and other items to enhance the greeting card experience of the recipient.

### CROSS-REFERENCE TO RELATED APPLICATIONS

This application claims priority from U.S. Provisional Application Ser. No. 61/995,493 filed Apr. 10, 2014, and from U.S. application Ser. No. 14/545,225 filed Apr. 8, 2015 and titled: “AN ENHANCED GREETING CARD CONFIGURED TO RECEIVE A RECEPTACLE FOR CONTAINING MEDIA CONTENT DATA STORED ON ONE OR MORE TYPES OF STANDARD DATA STORAGE DEVICES AND AN ENVELOPE CONFIGURED FOR RECEIVING THE GREETING CARD THEREIN WITH OR WITHOUT THE RECEPTACLE,” which is incorporated herein in its entirety by this reference.

### FIELD OF THE INVENTION

This invention relates to greeting cards and the enhancement thereof with data storage and/or recording media.

### BACKGROUND OF THE INVENTION

Sending photos, videos, text, poetry, art, literature, and similar media electronically as part of an electronic communication such as a text or an email to commemorate a special occasion has its drawbacks. First, it lacks the traditional feel of a physical greeting card. Relationships are important, and commemorating occasions such as Mother's Day, Father's Day, an Anniversary, a Birthday, or just to tell a loved one that they are special can be enhanced with a more personal and traditional touch. Secondly, the amount of media data that can be attached to such an electronic communication can be limited. If it's true that a picture's worth a thousand words, then sending a greeting card along with an abundance of media such as photos, videos, poetry, etc. with a traditional touch can be worth much more.

Traditional greeting cards are, however, limited to what the envelope accompanying the card can contain. Thus, attempts to include media with a traditional greeting card will likely require a larger mailing package, and even that can be content limiting and can require additional postage fees based on the increased size. Also, by deviating from the original envelope of the greeting card can also detract from the traditional greeting card style and attraction.

In the past, when sending media such as photos with a greeting card for a special occasion, a developed photo was sent with the greeting card. Today, media such as photos are often sent electronically as attachments to emails and texts and at different times. Compact disc storage cases are limited to one type of media storage device and aren't typical of packaging sent with a greeting card, gift card, photos etc.

### SUMMARY OF THE INVENTION

An embodiment of the invention allows a sender to safely and privately send photos, videos, music, literature, monetary gift cards and similar media stored on various types of storage devices along with a traditional greeting card that unlike an electronic message, does not leave such personal media vulnerable to hackers.

The sender selects a desired greeting card. If the sender desires to send photos, videos, literature and similar media, it can be stored on various known types of storage devices. The greeting card and envelope are designed to adapt to a receptacle of the invention. The storage devices are loaded with the desired media content, selective adhesive compartment covers are removed and the media storage devices are then inserted in their respective designated compartments of the receptacle. The receptacle is attached to the greeting card inserted into the designed envelope and mailed. Everything is sent and received in a single communication that maintains a more traditional and personal way of sending photo's, video's literature, and similar media on a special occasion.

An embodiment of the invention provides a sender a greeting card adapted to include a quality and quantity of photo's, video's, audio, literature, poetry, and other similar media within a greeting card and a stylish mailing package format, rather than being sent electronically with minimal privacy, security, and limitations on the amount of data that can be sent at one time.

A sender can design his or her own CD, DVD, poetry, graphic's, photo albums, etc. from an authorized website. This allows the receiver to view the visual content, listen to audio content and print the desired content. The recipient can receive access to an abundance of recorded content stored within the data storage devices, while being received in a package as small as a greeting card. The greeting card content can then be stored in the form of photo albums and labeled with a date and noting the occasion the card is intended to commemorate. An embodiment of the invention provides a method and apparatus that allows a sender of the greeting card to send an abundance of desired photo's, videos, music, art and literature etc., allowing the receiver to receive these items in a single communication having a traditional touch.

In one aspect of the invention, a greeting card is configurable to function in either a traditional mode or in an enhanced mode. The greeting card is configured to operate in the enhanced mode to facilitate being physically coupled with a receptacle. The receptacle can contain media data stored on one or more data storage devices. The receptacle has a spine that divides the receptacle into front and back receptacle covers. The spine defines first and second receptacle hinges along hingeable edges of the front cover and the back cover respectively.

The greeting card comprising includes a configurable hinge that divides the greeting card into front and back greeting card covers. The configurable hinge includes a first hinge that defines a hingeable edge of the front cover. The first hinge is operable in both the traditional and the enhanced modes to provide hingeable movement of the front cover along the hingeable edge of the front cover. A second hinge defines a hingeable edge of the back cover, the second hinge being operable only in the enhanced mode to provide hingeable movement of the back cover along the hingeable edge of the back cover.

The greeting card is initially configured to operate in the traditional mode by suppressing the second hinge from providing hingeable movement of the back cover independently of the first hinge. The greeting card is configured to operate in the enhanced mode by reversing the suppression of the second hinge to establish a spine between the first and second edges to permit independent operation of the first and second hinges, the configurable hinge being configured to receive the spine of the receptacle such that the first and second hinges of the configurable hinge are cooperatively aligned with the first and second receptacle hinges.

In a second aspect of the invention, the configurable hinge includes a first hinge that defines a common hingeable edge between the front cover and back covers. The first hinge is operable in both the traditional and the enhanced modes to provide hingeable movement of the front cover along the common hingeable edge. A bending guideline is established on an outside surface of the back cover of the greeting card, the bending guideline being parallel with the common hingeable edge. The greeting card is initially configured to operate in the traditional mode, whereby the first hinge provides hingeable movement of both the front and back covers of the greeting card along the common edge.

The greeting card is configured to operate in the enhanced mode by bending the back cover along the bending guideline to establish a second hinge along the bending guideline. A spine between the first and second hinges is also established to permit independent operation of the first and second hinges. The configurable hinge is configured in the enhanced mode so that the established spine of the greeting card receives the spine of the receptacle such that the first and second hinges of the configurable hinge are cooperatively aligned with the first and second receptacle hinges.

### BRIEF DESCRIPTION OF THE DRAWINGS

FIG. 1 shows the receptacle fastened within an open greeting card between a literature sheet and a back cover of the card with an adhesive removable cover covering a medium compartment.

FIG. 2 shows the greeting card with two hinges and a crease therebetween along the length of the spine of the greeting card.

FIG. 3 shows the greeting card adapted for accepting the receptacle.

FIG. 4 shows the invention with the receptacle fastened within an open greeting card between the literature sheet and the back of receptacle with an adhesive removable cover removed from a medium compartment.

FIG. 5 shows the front cover, spine and back of the receptacle with fastening strips along the back of the receptacle.

FIG. 6 shows a top view of the receptacle fastened within the greeting card.

FIG. 7 shows a view of the accordion design envelope partly expanded to accept the greeting card with the receptacle fastened therein.

FIG. 8 shows the accordion design envelope with the greeting card and receptacle inserted within the accordion design envelope.

FIG. 9A shows the configurable hinge whereby the fold is held in place by a defeatable adhesive that permits the greeting card to be used traditionally with one hinge.

FIG. 9B shows the configurable hinge whereby the fold is held in place by a removable tape that permits the greeting card to be used traditionally with one hinge.

FIG. 10A shows the configurable hinge whereby a slit is used instead of a crease to create a bending point for establishing a second hinge.

FIG. 10B shows the configurable hinge whereby the fold has been made at the slit to establish the second hinge.

FIG. 10C shows the configurable hinge whereby the second hinge is established to create a spine into which the spine of the receptacle is inserted.

Reference Numeral Key for the Drawings

| | |
|---|---|
| 100 Enhanced Greeting Card | 33 compact disc compartment |
| 1, 201 greeting card component | 35 Disc release button |
| 2, 202 configurable hinge | 37 compact disc |
| 3 front cover of greeting card component | 39 storage device or USB |
| | compartment |
| 5, 205, 5′, 205′ living double hinge | 41 storage device or USB |
| 7, 207 spine of greeting card component | 43 monetary value device |
| | compartment |
| 9 crease of the greeting card component | 45 monetary value device |
| 11 back cover of greeting card component | 47 monetary value device |
| | brace |
| 13 literature sheets | 49 storage device supports |
| 15 receptacle component | 51 finger recess |
| 17 front cover of receptacle component | 53 male tab |
| 19 clear laminate | 55 female slot |
| 21 advertisement | 57 adhesive |
| 23 custom insert | 59 adhesive compartment |
| | covers |
| 25 spine of receptacle component | 61 accordion design envelope |
| 27, 27′ living double hinge of receptacle | 4 weak adhesive |
| 29 back cover of receptacle component | 211 hingeable slits |
| 31 receptacle component body | 6 adhesive tape |

### DETAILED DESCRIPTION

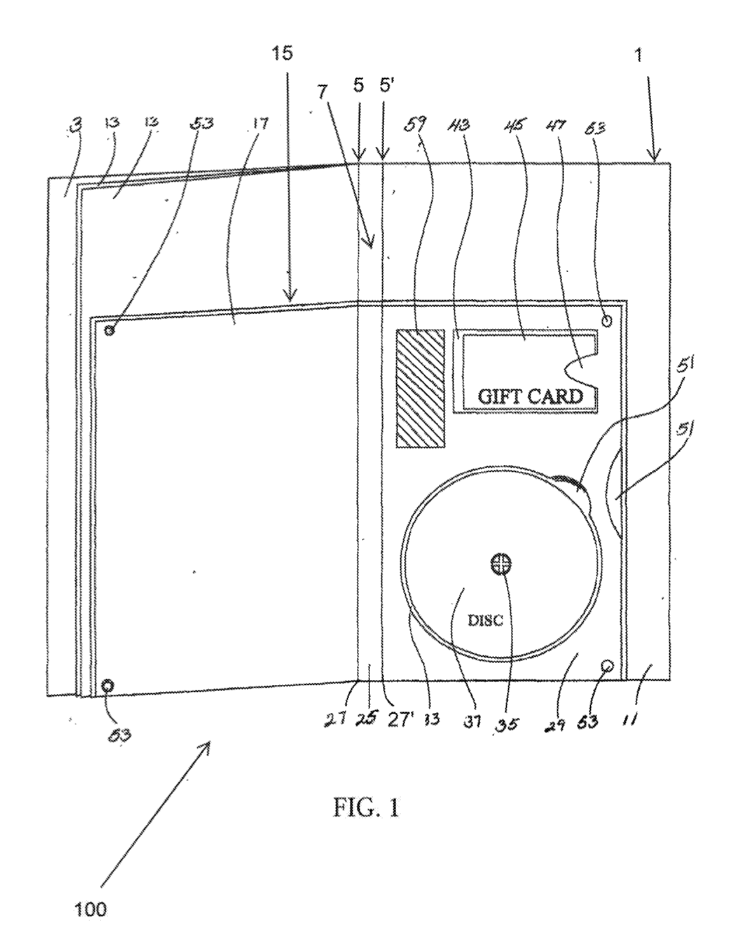

FIGS. 1-4 and 6 illustrate an enhanced greeting card 100 that includes a greeting card component 1 having a configurable hinge 2, 202 that can be configured to operate in either a traditional greeting card mode, where the front 3 and back cover 11 of the greeting card 1 have a single operable hinge 5 between them, or in an enhanced mode. In the enhanced mode, the configurable hinge 2, 202 provides first and second hinges 5 and 5′ respectively, and a spine 7 therebetween, enabling independent hinging of the front 3 and back 5 covers. This enhanced mode of the greeting card and its configurable hinge 2, 202 further facilitates coupling of the greeting card 1 and a receptacle component 15 (FIGS. 1, 4-5 and 6). Receptacle 15 has a fixed double hinge 27, 27′ establishing spine 25 therebetween. The spine 25 of receptacle 15 can therefore be inserted into the spine 7 of greeting card 1 such that the receptacle 15 fits within the dimensions of the front cover 3, the back cover 11, and the spine 7 of greeting card 1. Moreover, the hinges 5 and 5′ of the greeting card 1 align with the hinges 27, 27′ of the receptacle for cooperative operation. The receptacle component 15 is configured to be attached or adhered to the greeting card component 1 as illustrated in FIGS. 1, 4, and 6 to create the enhanced greeting card 100.

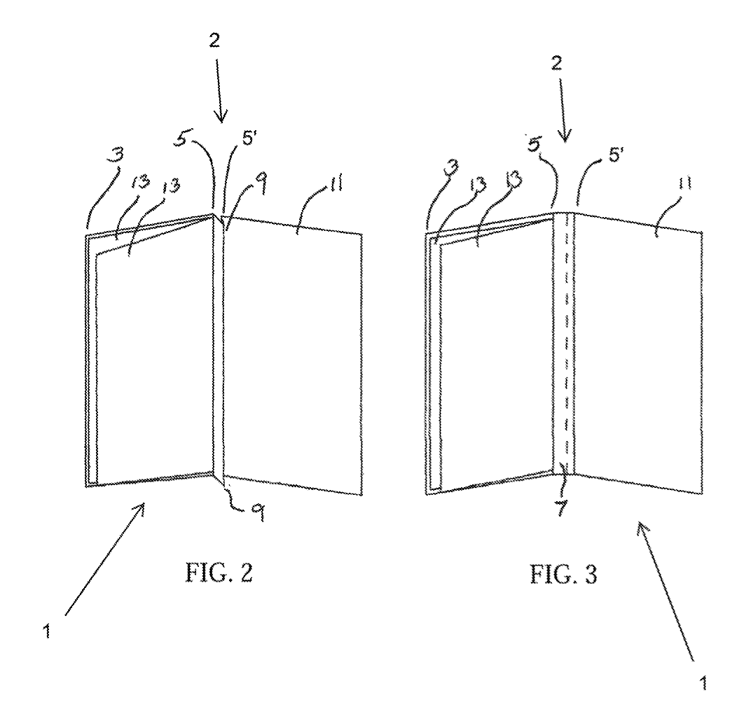

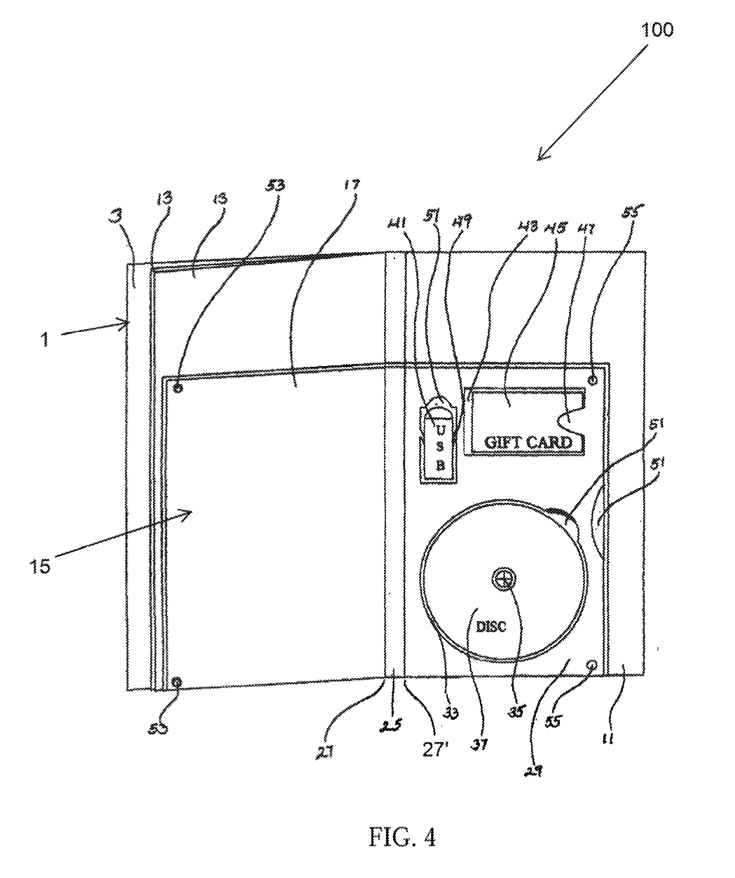

The configurable hinge 2, 202 of greeting card 1 can have a crease 9 along the spine 7 between the two hinges 5, 5′ as shown in FIGS. 2 and 3. This is unlike a traditional greeting card, which usually has only one living hinge, but the crease allows the greeting card to operate as if it has a single hinge when it is not combined with a receptacle 15. The crease 9 creates folds in the spine that flattens the spine 7 and hinge 5′ against the front cover and causes the two living hinges 5, 5′ of the greeting card to operate as a single hinge 5 at the front cover 3 of the greeting card 1, in a manner similar to that of a traditional single-hinged greeting card (FIG. 2). Flattening the crease 9 re-establishes the spine 7 and enables two hinge operation of the greeting card at 5 and 5′ by expanding the spine 7 of the greeting card 1 to enable it to receive the spine of 25 of the receptacle 15 (FIG. 3).

The crease 9 along the spine 7 of the greeting card 1 does not necessarily have to be centered evenly between the living hinges 5, 5′ of greeting card 1 as is shown in FIGS. 2 and 3. By offsetting the crease 9 along the spine 7 of greeting card 1, just one portion of spine 7 that includes the hinge 5 that is coupled to the front cover 3 of greeting card 1 will be visible when facing the front cover 3 of greeting card 1.

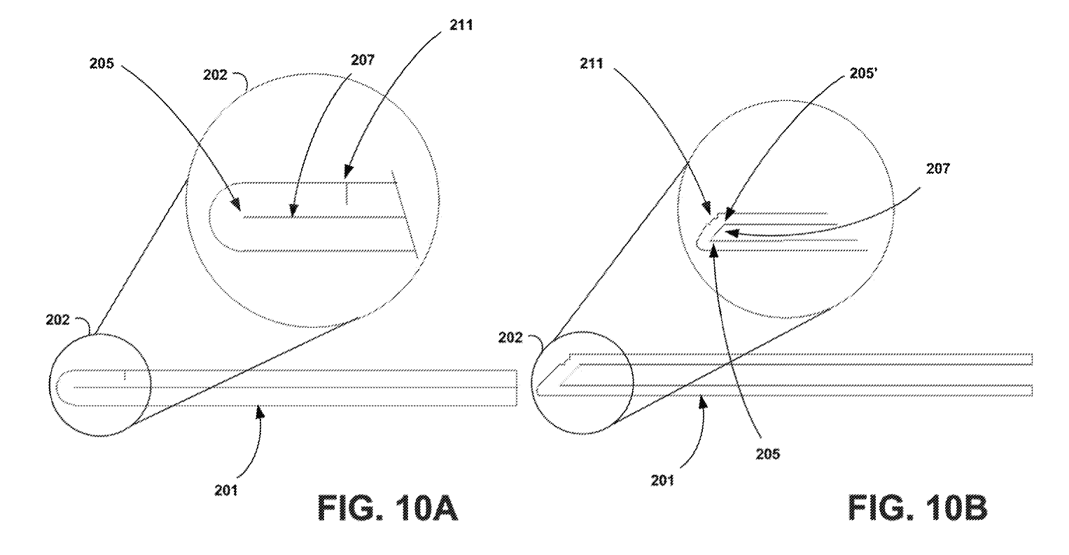

FIGS. 9A and 9B show additional embodiments of the configurable hinge 2. FIG. 9A shows that the crease 9 can be held in the folded or single hinge operational position through the use of a weak adhesive or even a restickable glue 4 that can be applied to the surfaces of the folds and the inside surface of the back cover 11. This prevents any hingeable movement along the second hinge 5′, and the back cover 11 essentially shares the hingeable movement provided the first hinge 5. Thus, when hinge 5′ is suppressed, the configurable hinge 2 operates in the traditional greeting card mode.

The hinge 2 can be configured to operate in the enhanced mode by pulling adhered folds and the back cover 11 to permit the crease 9 to be flattened out of the spine 7 and to establish independent operation of both hinges 5, 5′ of the enhanced mode. The front 3 and back 11 covers now have their own hinges 5 and 5′ respectively and are able to hingedly move independent of one another. In this mode, coupling the card 1 with a receptacle 15 is now enabled. If the adhesive 4 is restickable, the greeting card 1 can be reconfigured to operate once again as a traditional greeting card by reestablishing the traditional mode configuration of configurable hinge 2.

FIG. 9B shows an alternate way of maintaining the traditional configuration of the configurable hinge 2. A wrap of tape 6 can be used to hold the crease 9 in the folded position until mating with a receptacle 15 (not shown) is desired. The tape 6 can be broken and unwrapped or peeled away from the configurable hinge 2. The applied adhesive 4 or the tape 6 can hold the crease 9 in the folded position, and thus in the traditional greeting card mode while the greeting card 1 is for sale. The greeting card can be therefore be sold to those who would like a traditional greeting card as well as to those who want and an enhanced greeting card 100. The greeting card 1 can be sold separately from the receptacle, and the greeting card 1 can be easily configured to provide the enhanced operation by which to incorporate the receptacle to create the enhanced greeting card 100 as described above.

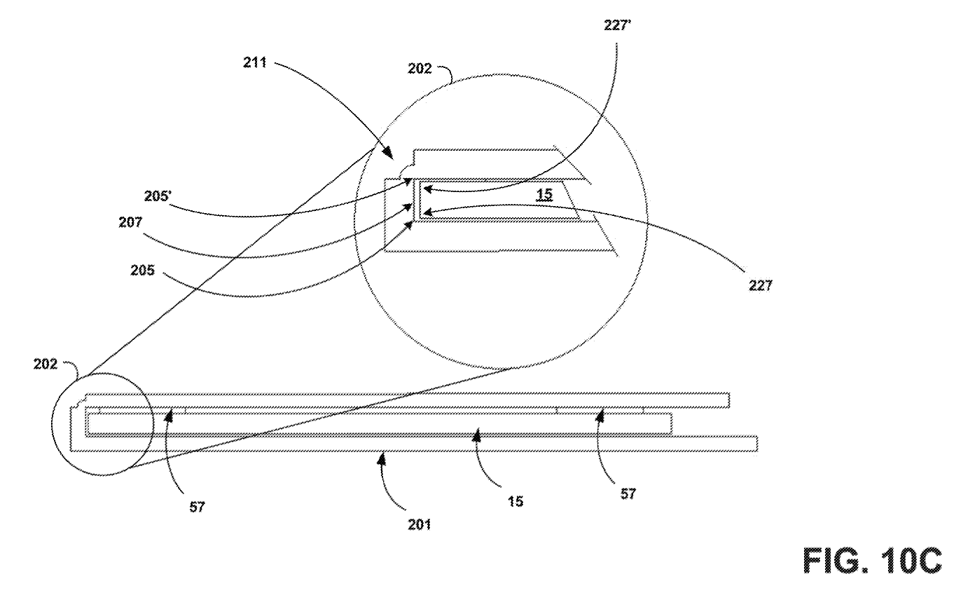

FIGS. 10A-B illustrate a second embodiment of the greeting card 201 with a configurable hinge 202 that requires no crease or adhesive, but instead employs a bending guideline 211 disposed on an outside surface of the back cover 11 of the greeting card 201. In the traditional mode of configuration of the configurable hinge 202 as illustrated in FIG. 10A, only a single hinge 205′ exists and is shared by the front 3 and back 11 covers of greeting card 201. Thus, there is no need to suppress a second hinge while in initially in the traditional mode of operation. The greeting card 201 can be sold in this state and needs only to be configured in an enhanced state should a buyer wish to create an enhanced greeting card 100.

To configure the configurable hinge 202 in the enhanced mode, one need only bend the back cover 11 along the bending guideline 211 to establish a second hinge 205′ and spine 207 as shown in FIG. 10B. In an embodiment, the bending guideline can more easily facilitate the bending process if it is a line of weakness such as slit or perforation 211 that has been patterned or scored into the greeting card 201 as shown. Once the second hinge 205′ and the spine 207 are established, mating the greeting card 201 with a receptacle 15 can be accomplished as illustrated in FIG. 10C. In FIG. 10C, the spine 25 of receptacle 15 has been inserted into the spine 207 of the greeting card 201 such that hinges 205, 205′ are aligned with hinges 27, 27′ so that they operate cooperatively. If the line of weakness 211 is sufficiently resilient, the configurable hinge 202 can be restored to the traditional greeting card mode by flattening and eliminating the spine 207 as well as hinge 205′. Those of skill will appreciate that in either embodiment, the spine 7, 207 is of a dimension suitable to receive the receptacle spine 25 and to achieve cooperative alignment of the two sets of hinges.

The greeting card 1 may also have multiple literature sheets 13, preferably located between or within the front cover 3 of greeting card 1, and a front cover 17 of the receptacle 15 as is shown in FIGS. 1, 2, 3, 4, and 6. This can be accomplished by attaching the literature sheets 13 to the first hinge 5, 205.

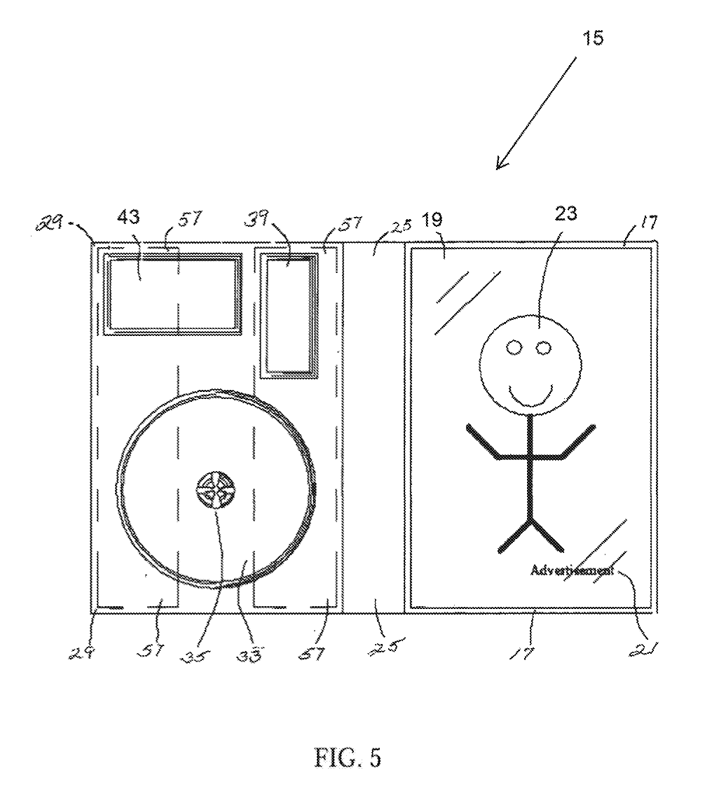

The receptacle 15 is configured to receive and retain at least one storage device as shown in FIGS. 1 and 4, each of which may have prerecorded or recorded photos, images, literature, videos, music, records, and other media data stored thereon.

The receptacle 15 may be constructed by the same method as known compact disc storage packs, or may be constructed by other methods such as, but not limited to, injection molding. The receptacle can be made in a vast arrange of colors and may be made of recyclable materials.

The receptacle 15 includes a front cover 17, a spine 25, living hinges 27, 27′ a back cover 29, storage body 31 formed between the cover 17 and the back cover 29. Receptacle 15 further includes finger recesses 51, male tab 53, female slot 55, compact disc compartment 33, storage device or USB compartment 39, monetary value device compartment 43, clear laminate 19, advertisement 21, fastening means 57, which can be for example, and adhesive strip or two-way tape, as illustrated in FIGS. 1, 4 and 5.

The front cover 17 and the back cover 29 of receptacle 15 are connected to the spine 25 by living hinges 27, 27′ of the receptacle 15.

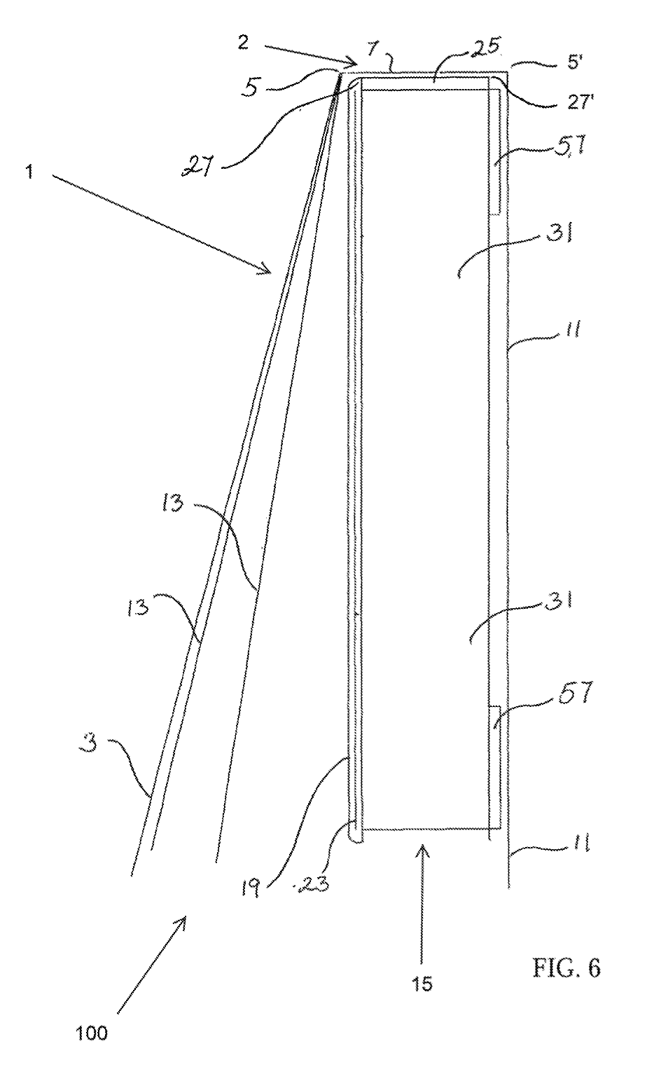

The clear laminate 19 is fastened to the three sections of the receptacle 15 and is preferably fastened to at least the front cover 17. The clear laminate 19, is fastened on three sides leaving at least one side open as shown in FIG. 5. This allows an insert 23, such as but not limited to a title of an occasion, a photo, a poem, etc. to be inserted thru the side of the clear laminate 19, which is preferably not fastened to the front cover 17 of receptacle 15. The clear laminate 19 can also have an advertisement 21 on one side, which allows the company or publisher of the greeting card 1 and receptacle 15 to advertise their product to the sender and receiver, such as through providing a view of the brand name or trademark as shown in FIG. 5.

The storage body 31 formed between the front and back covers of receptacle 15 may include a compact disc compartment 33, which holds in place at least one compact disc, CD, DVD, etc. as shown in FIGS. 1, 4 and 5. The disc release button 35 has two functions. The disc release button 35 as shown in FIGS. 1, 4 and 5 holds the disc in place, and releases the disc when pressed in a downward direction while using the finger recess 51 to lift the edge of the compact disc 37 in an upward direction. Button 35 may be of many different known designs. Compact disc packs or cases have a variety of known designs for a compact disc release apparatus.

The storage device or USB compartment 39 consists of the storage device supports 49, which secure the storage device or USB drive 41 when the storage device or USB drive 41 is stored in the receptacle 15 as shown in FIG. 4. Finger recess 51 allows the storage device, or USB drive 41 to be removed with a finger.

The monetary value device compartment 43 includes a monetary value device brace 47 as shown in FIGS. 1 and 4. Once the storage devices have been loaded with stored media data, the compartment covers 59 are removed and the media storage devices are inserted into their designated compartments. The compartment covers can be made of an adhesive, strip of material. The receptacle 15 is then closed by pressing male tabs 53 of front cover 17 of receptacle 15 into female slots 55 of the storage body 31. The compartment covers 59 may be left to cover unused compartments when a particular type of storage device for the unused compartment is not used. The compartment covers may cover the compartments at the time of purchase and then removed, or vice versa.

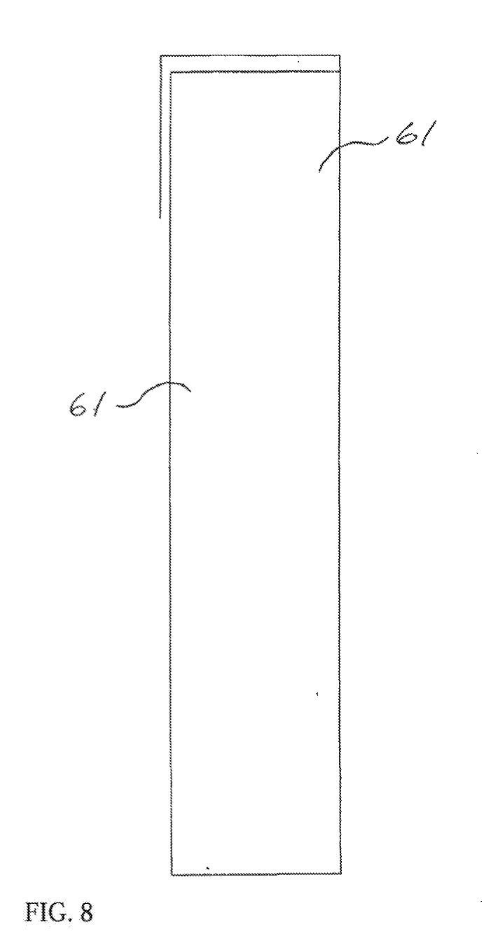

The accordion design envelope 61, as shown in FIG. 7 can be produced a vast range of colors, and preferably a color that matches the greeting card 1, or that is appropriate for the occasion to which the greeting card is to commemorate (e.g. red for Valentine Day).

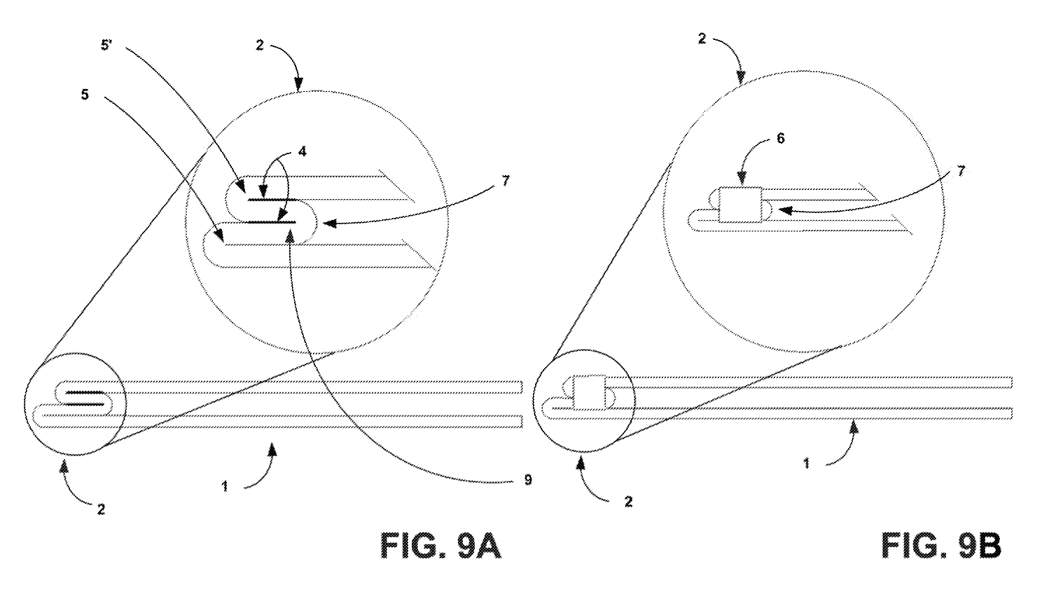

The accordion design of envelope 61 serves multiple purposes, including making it more compact when placed in a flattened state during shipping from a manufacture, thereby saving space, which saves on shipping costs and lessens the chance of damage. The accordion design further permits the envelope to expand to the dimensions of the combination of the greeting card 1 and receptacle 15 to accommodate the combination as shown in FIG. 8.

Thus, a sender or giver can select and purchase the greeting card 1, that is designed, constructed and or formatted as shown in FIGS. 2 and 3. If the sender wishes to also send media such as photos, videos, music, literature, monetary gift cards, and the like, using the receptacle 15, the selected greeting card 1 is then reconfigured with the purchase and attachment to greeting card 1 of a receptacle 15 as shown in FIG. 3. The selected greeting card 1 configured so that it can be sent with or without the receptacle 15 as shown in FIGS. 2 and 3. Thus, a manufacturer of greeting cards can construct a single design for their greeting cards (i.e. greeting card 1) that can be sold as a conventional greeting card, but that can be reconfigured to accommodate the receptacle 15 as shown in FIGS. 1, 2, 3, 4, and 6 if a purchaser wishes to send media with the greeting card 1.

If the user wishes to send media, the sender fills out the greeting card 1 then loads the media storage devices with desired media data, such as, but not limited to, photos, audio, video, data etc. The manufacturer of greeting card 1 may have a designated web site were the sender or giver may login for a fee or a free download of graphics, art, literature, poetry, video's, etc., or any other content that the manufacturer provides to be downloaded from their website. The sender can then combine and design his/her own literature, photo's, video's etc., with downloads of graphics, art, literature, poetry, videos, etc., from the website to send a customized greeting.

Once the storage devices have been loaded, if the storage compartments are covered with the compartment covers 59, the selected compartment covers 59 can be removed and the appropriate storage devices are then inserted into their designated storage compartments. The storage device supports 49 secure the storage devices in their designated compartments as shown in FIGS. 1 and 4. The compartment covers 59 may be placed over the unused compartments if any, so that it doesn't seem that a storage device is missing.

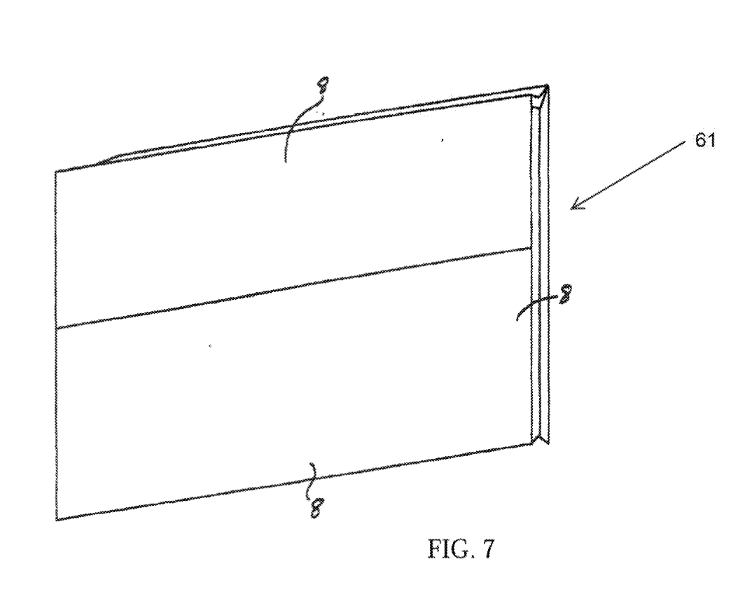

The receptacle 15 can be closed and secured by tab 55, as shown in FIG. 6.

The insert 23, may be a photo, poetry, etc., and is inserted between the clear laminate 19, and front cover 17 of receptacle 15, as shown in FIG. 5. The greeting card 1, is then formatted or configured to accept the receptacle 15 shown in FIGS. 1, 3, 4 and 6.

The greeting card 1, is opened flat with the face and back of the greeting card 1 facing downward and the inner side of the greeting card 1 is facing upward. A finger can be used to press out the crease 9 to expand the spine 7 to receive spine 25 of the receptacle and to configure the greeting card to operate with both hinges 5, 5′.

The receptacle 15 is then attached to the greeting card 1 and fastened by fastening means two-way tape 57 as shown in FIGS. 1, 4 and 6.

Receptacle 15 in a closed state is then laid flat with front cover 17 of receptacle 15 laying face down on the inner side of the front cover 3 of greeting card 1, and the back cover 29 of receptacle 15 facing upward. The spine 25 of receptacle 15 and spine 7 of greeting card 1 are aligned with each other, with the bottom of the receptacle 15 being flush with the bottom of the greeting card 1. This allows the weight of the receptacle 15 to support the greeting card 1 when placed in a standing position as shown in FIGS. 1, 4 and 6.

Once the greeting card 1 and the receptacle 15 are properly positioned (preferably with the spine 25 of the of the receptacle 15 pressed into the spine 7 of greeting card 1, and the bottom edges of the receptacle 15 flush with the bottom edges of the greeting card 1), the non-adhesive strip of the two-way tape 57 is removed and the back cover of greeting card 1 is pressed on to the back cover 29 of receptacle 15, as shown in FIGS. 1, 4 and 6.

The combination of the greeting card 1 and receptacle 15 with loaded media storage devices, is placed into the accordion design envelope 61 as shown in FIG. 8. and can be mailed.

When the recipient opens the greeting card 1, the storage devices can be removed from the receptacle and connected to an appropriate viewing device, the recipient can view the content included by the sender. The literature, art, photos, videos, music etc. can be selectively printed by the receiver. This allows the sender to send a quantity of contents and allows the receiver to print just the desired contents of their choice. The storage devices can then be reinserted into their designated compartments of the receptacle 15 and can be closed and the greeting card 1 placed on a self in a standing position which can be made part of a photo, video, audio, etc., album. A title and date may be written on the spine 7 of greeting card 1 to identify each individual, occasion, card, or album.

While I have shown, and described in considerable detail, what I consider to be the preferred form of my invention, it will be understood by those skilled in the art that various changes may be made in the shape ‘and arrangement of the several parts of the device, and that such details are not to limit the scope of my claims.

What is claimed is:

1. A greeting card configurable to function in either a traditional mode or in an enhanced mode, the greeting card being configured in the enhanced mode to be physically coupled with a receptacle for containing media data stored on one or more data storage devices, the receptacle having a spine that divides the receptacle into front and back receptacle covers, the spine defining first and second receptacle hinges along hingeable edges of the front cover and the back cover respectively, the greeting card comprising:
a configurable hinge dividing the greeting card into front and back greeting card covers, the configurable hinge including:
a first hinge defining a hingeable edge of the front cover, the first hinge being operable in both the traditional and the enhanced modes to provide hingeable movement of the front cover along the hingeable edge of the front cover; and
a second hinge defining a hingeable edge of the back cover, the second hinge being operable only in the enhanced mode to provide hingeable movement of the back cover along the hingeable edge of the back cover,
wherein the greeting card is initially configured to operate in the traditional mode by suppressing the second hinge from providing hingeable movement of the back cover independently of the first hinge, and
wherein the greeting card is configured to operate in the enhanced mode by reversing the suppression of the second hinge to establish a spine between the first and second edges to permit independent operation of the first and second hinges, the configurable hinge being configured to receive the spine of the receptacle such that the first and second hinges of the configurable hinge are cooperatively aligned with the first and second receptacle hinges.

2. The greeting card of claim 1 wherein the second hinge of the configurable hinge is suppressed by folding the spine to create a crease establishing folds in the spine, adhering the folds of the crease together and adhering the back cover to the folds of the crease so the only hingeable movement created by the configurable hinge when the greeting card is in the traditional mode is that created by the first hinge.

3. The greeting card of claim 2 wherein the adhesive is a weak adhesive, and the greeting card is configured to operate in the enhanced mode by pulling the back cover from the folds and pulling the adhered folds apart to establish a flattened spine, thereby permitting the second hinge of the configurable hinge provide hingeable action of the back cover independent of the first hinge.

4. The greeting card of claim 3 wherein the adhesive is a weak adhesive applied to the surfaces of the folds and back cover.

5. The greeting card of claim 3 wherein the adhesive is a weak adhesive tape wrapped around the outside of the folds and the back cover to hold the back cover to the folds, and the tape can be removed to pull the folds apart and establish the flattened spine.

6. The greeting card of claim 3 wherein the adhesive is a restickable adhesive that permits the greeting card to be reconfigured back to the traditional mode from the enhanced mode.

7. The greeting card of claim 1, wherein the dimensions of the greeting card are larger than the dimensions of the receptacle, so that the receptacle covers are completely covered by the greeting card covers.

8. The greeting card of claim 1, further including literature sheets, the literature sheets being bound to the configurable hinge inside the front cover of the greeting card at the first hinge.

9. The greeting card of claim 1 wherein an outside surface of the back cover of the receptacle is adhered to an inside surface of the back cover of the greeting card after inserting the spine of the receptacle into the spine of the greeting card.

10. The greeting card of claim 9 wherein the front and back covers of the greeting card and the front and back covers of the receptacle component all have a bottom edge, and the bottom edges of the front covers and the bottom edges of the back covers are aligned before adhering the receptacle to the greeting card so that the receptacle component provides support necessary to maintain the enhanced greeting card in an upright standing position.

11. A greeting card configurable to function in either a traditional mode or in an enhanced mode, the greeting card being configured in the enhanced mode to be physically coupled with a receptacle for containing media data stored on one or more data storage devices, the receptacle having a spine that divides the receptacle into front and back receptacle covers, the spine defining first and second receptacle hinges along hingeable edges of the front cover and the back cover respectively, the greeting card comprising:
a configurable hinge dividing the greeting card into front and back greeting card covers, the configurable hinge including:
a first hinge defining a common hingeable edge between the front cover and back covers, the first hinge being operable in both the traditional and the enhanced modes to provide hingeable movement of the front cover along the common hingeable edge; and
a bending guideline on an outside surface of the back cover of the greeting card, the bending guideline being parallel with the common hingeable edge,
wherein the greeting card is initially configured to operate in the traditional mode whereby the first hinge provides hingeable movement of both the front and back covers of the greeting card along the common edge, and
wherein the greeting card is configured to operate in the enhanced mode by bending the back cover along the bending guideline to establish a second hinge along the bending guideline and a spine between the first and second hinges to permit independent operation of the first and second hinges, the configurable hinge being configured so that the established spine of the greeting card receives the spine of the receptacle such that the first and second hinges of the configurable hinge are cooperatively aligned with the first and second receptacle hinges.

12. The greeting card of claim 11 wherein the bending guideline is a line of weakness formed at least partially below the outside surface of the back cover to facilitate formation of the second hinge.

13. The greeting card of claim 9 wherein the line of weakness is formed as a perforation.

14. The greeting card of claim 9 wherein the line of weakness is formed as a slit.

15. The greeting card of claim 9 wherein the line of weakness is scored into the outside surface of the greeting card cover.

16. The greeting card of claim 9 wherein the line of weakness is separated from the first hinge by a dimension that is adequate for the established spine of the greeting card to accommodate the spine of the receptacle.

17. The greeting card of claim 1, wherein the dimensions of the greeting card are larger than the dimensions of the receptacle, so that the receptacle covers are completely covered by the greeting card covers.

18. The greeting card of claim 11, further including literature sheets, the literature sheets being bound to the configurable hinge inside the front cover of the greeting card at the first hinge.

19. The greeting card of claim 11 wherein an outside surface of the back cover of the receptacle is adhered to an inside surface of the back cover of the greeting card after inserting the spine of the receptacle into the spine of the greeting card.

20. The greeting card of claim 19 wherein the front and back covers of the greeting card and the front and back covers of the receptacle component all have a bottom edge, and the bottom edges of the front covers and the bottom edges of the back covers are aligned before adhering the receptacle to the greeting card so that the receptacle component provides support necessary to maintain the enhanced greeting card in an upright standing position.
